(19) United States
(12) Patent Application Publication
(10) Pub. No.: US 2020/0062145 A1
(43) Pub. Date: Feb. 27, 2020

(54) CROSS-CAR MOVEABLE HEADREST ASSEMBLY

(71) Applicant: WINDSOR MACHINE AND STAMPING (2009) LTD., Windsor (CA)

(72) Inventor: Mark Little, Windsor (CA)

(21) Appl. No.: 16/545,774

(22) Filed: Aug. 20, 2019

Related U.S. Application Data
(60) Provisional application No. 62/721,904, filed on Aug. 23, 2018.

(51) Int. Cl. B60N 2/02; B60N 2/868; B60N 2/853

(52) U.S. Cl. CPC B60N 2/0248; B60N 2/891; B60N 2/853; B60N 2/868

(57) ABSTRACT

A headrest assembly moveable in a cross-car direction along an upper portion of a seatback. The headrest assembly includes a seatback track member and a headrest track member that are operably connected for relative sliding movement therebetween. Movement of the headrest assembly in the cross-car direction can be automated via a motor and a controller. Certain safety features may be implemented such as a maximum range of motion of the headrest assembly in accordance with specific software implemented instructions. Stored profiles are accessible such that each headrest assembly associated with a passenger's seat can be moved into preferred locations for minimum visual obstruction when not in use. In addition, movement of the headrest assembly in the cross-car direction can also be effectuated manually.

### CROSS-REFERENCE TO RELATED APPLICATION

This U.S. patent application claims the benefit of and priority to U.S. Provisional Patent Application Ser. No. 62/721,904, filed on Aug. 23, 2018, titled “Cross-Car Moveable Headrest Assembly,” the entire disclosure of which is hereby incorporated by reference.

### BACKGROUND OF THE INVENTION

### 1. Field of the Invention

The present invention relates to vehicle headrests and, more particularly, to a headrest assembly that is moveable in a cross-car direction.

### 2. Related Art

This section provides background information related to the present disclosure which is not necessarily prior art.

Technological improvements of vehicles have generally been focused on enhancements to features including efficiency, safety, and comfort. In a race to improve these features, certain matters of conveniences are often overlooked. These technological conveniences not only make an occupant's travel experience more enjoyable, they tangentially result in improvements to efficiency, safety, and comfort. More specifically, a more enjoyable travel experience results in longer periods of driving between stops and can also encourage less movement of occupants during travel.

One example feature of a vehicle that has historically been employed only for safety and comfort is a headrest. Most vehicles include headrests atop an occupant's seat and in a position adjacent the occupant's head. Headrests have historically been limited to movement in a vertical direction and/or a fore-aft direction. However, a seated occupant may prefer to have the headrest positioned in additional positions for resting/sleeping. Moreover, forward facing headrests decrease the visibility and cargo space within a vehicle. Because forward facing headrests have historically taken up space and because accommodating user preferences have been limited in directions of adjustment, there is a continuing desire to provide additional functionality to the headrest.

### SUMMARY OF THE INVENTION

This section provides a general summary of the disclosure and is not to be interpreted as a complete and comprehensive listing of all of the objects, aspects, features and advantages associated with the present disclosure.

In accordance with one aspect, the present invention provides a headrest assembly for use in a motor vehicle. The headrest assembly comprises a housing, an armature operatively coupling the housing to a seatback of a vehicle seat, and a horizontal adjustment mechanism operatively coupled to the armature. The horizontal adjustment mechanism effectuates movement of the housing in a cross-car direction.

In accordance with another aspect, the present invention provides a method of controlling the movement of a headrest assembly in a cross-car direction with a motor that receives instructions from a microprocessor. The microprocessor is configured to obtain a request to move the headrest assembly in a cross-car direction and, in response, instruct the motor to move the headrest assembly in the cross-car direction.

In accordance with yet another aspect, the present invention provides a vehicle including a plurality of vehicle seats that each include a headrest assembly. Each of the headrest assemblies comprise a housing, an armature operatively coupling the housing to a seatback of the vehicle seat, and an horizontal adjustment mechanism operatively coupled to the armature. The horizontal adjustment mechanism effectuates movement of the housing in a cross-car direction of the vehicle.

### BRIEF DESCRIPTION OF THE DRAWINGS

The drawings described herein are for illustrative purposes only of selected embodiments and are not intended to limit the scope of the present disclosure. The inventive concepts associated with the present disclosure will be more readily understood by reference to the following description in combination with the accompanying drawings wherein:

FIG. 1 is a perspective view of a headrest assembly that is moveable in a cross-car direction;

FIG. 2 is a sectional view of a horizontal adjustment mechanism of the moveable headrest assembly taken along line A-A of FIG. 1;

FIG. 3 is a side view of the headrest assembly with the horizontal adjustment mechanism located in a vehicle seatback in accordance with another aspect of the disclosure;

FIG. 4 is a disassembled view of various components of the headrest assembly from FIG. 3;

FIG. 5 is a top view of the horizontal adjustment mechanism and a corresponding seatback in accordance with yet another aspect of the disclosure;

FIG. 6 is a top view illustrating a range of movement of the headrest assembly with respect to the vehicle seatback;

FIG. 7 is a schematic view of electrical and mechanical components of the headrest assembly; and

FIG. 8 is a method flow chart including steps in accordance with the application of the headrest assembly.

### DESCRIPTION OF THE ENABLING EMBODIMENT

Example embodiments will now be described more fully with reference to the accompanying drawings. In general, the subject embodiments are directed to a headrest assembly for a vehicle that is moveable in a cross-car direction. However, the example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Referring to the Figures, wherein like numerals indicate corresponding parts throughout the views, the headrest assembly is intended for providing an enhanced travel experience to occupants of a vehicle by allowing the headrest assembly to be moved in a cross-car direction.

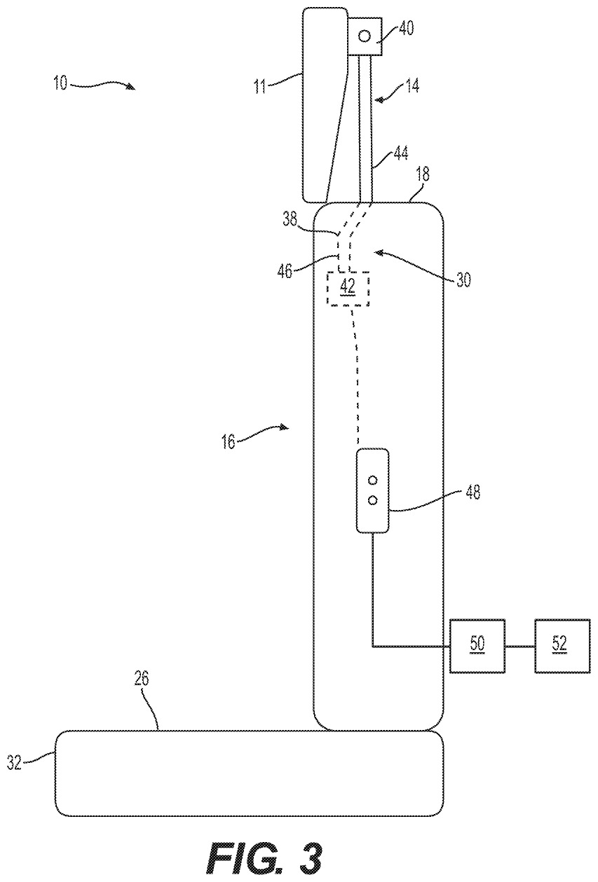

Referring to FIG. 1, a headrest assembly is depicted. The headrest assembly is generally referred to with numeral 10. The headrest assembly 10 includes a housing 11 (FIG. 3) that at least partially encloses several components associated with stabilization and/or adjustment of the headrest assembly 10. A cushion (not shown) and a cover 12 are provided over the housing for aesthetic purposes and occupant comfort. A base portion 14 (which may also be referred to as an “armature”) is mountable to a vehicle seat and, more specifically, to a top surface 18 of a seatback 16 of the vehicle seat.

The headrest assembly 10 is typically positioned atop the seatback 16. The embodiments described herein allow movement of the headrest assembly 10 in a cross-car direction 20 along the top surface 18 of the seatback 16. The extent of the movement of the headrest 10 may vary depending upon the particular application of use. In some embodiments, the headrest 10 is moveable in the cross-car direction 20 linearly along the upper surface 18, but in other embodiments the headrest 10 is rotatably moveable around a corner 22—or rounded corner—of the seatback 16 to allow movement to a side surface 24 of the seatback 16. It is to be appreciated that the cross-car movement may be in either direction and around either corner 22 of the seatback 16.

Movement in the cross-car direction 20, particularly to a side position (i.e., along the side surface 24), significantly enhances adjustability options for seated occupants and provides additional cargo space and visibility for unoccupied seats. For example, a seated occupant may prefer to have the headrest cushion positioned along a side of the seatback 16 for resting/sleeping, as this increases head support from the side.

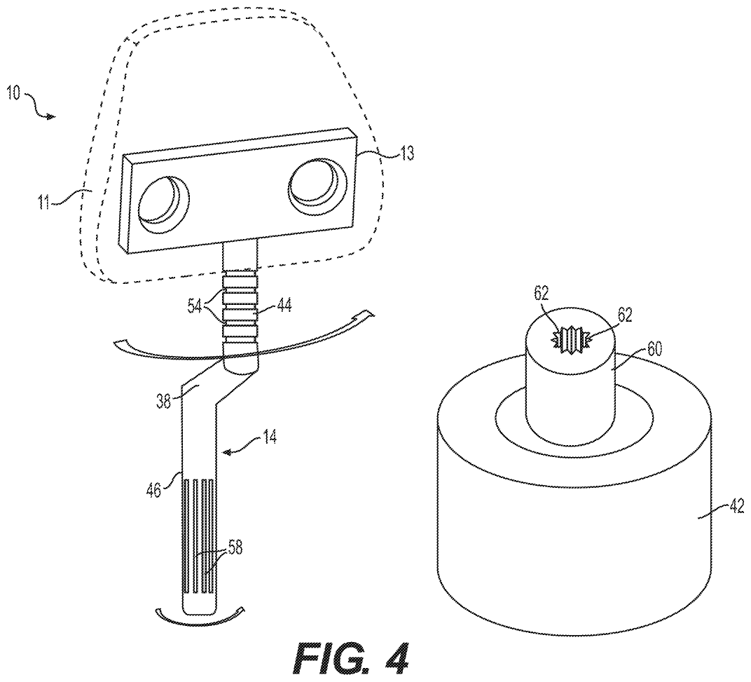

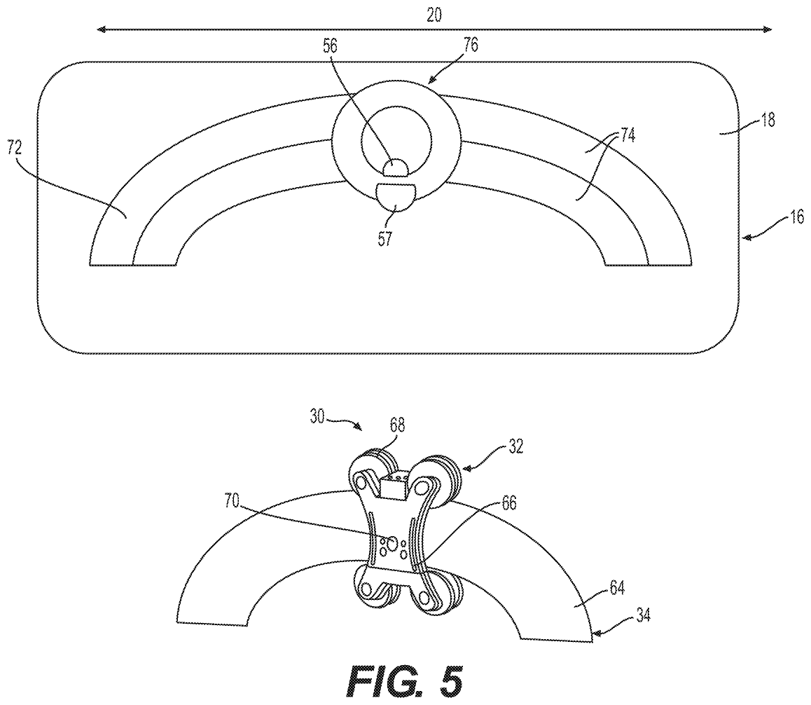

Movement of the headrest assembly 10 may be made manually or in an electromechanical manner. Manual adjustment may include interaction by a user with an unlocking feature (FIG. 5) to unlock the headrest position for manual movement in the cross-car direction 20. Electromechanical actuation is made with at least one actuator (FIGS. 3 and 4) that is disposed in the headrest assembly 10 and/or the seatback 16. The actuator may vary depending upon the particular application of use. In some embodiments, the actuator comprises one or more motors operatively coupled to an adjustment mechanism that facilitates cross-car adjustment of the headrest assembly 10.

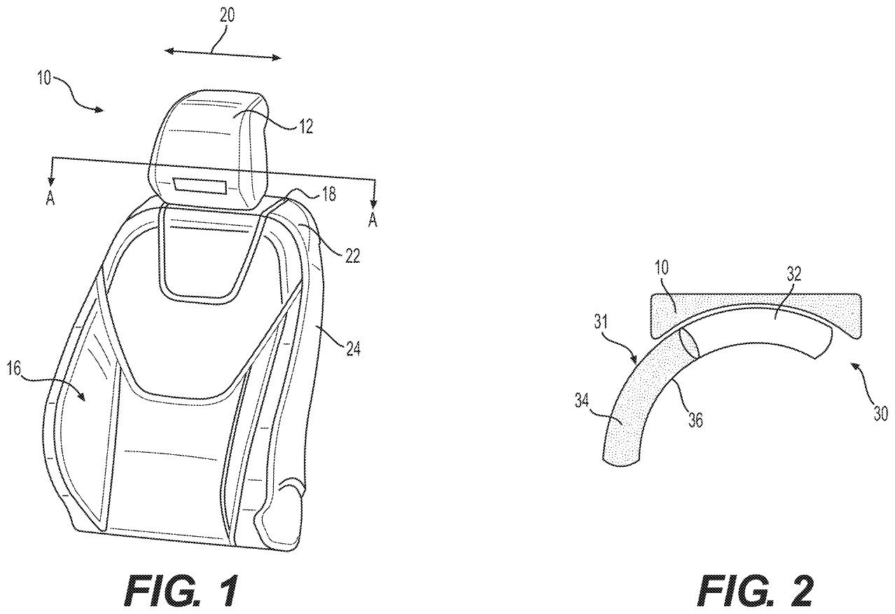

Referring now to FIG. 2, regardless of whether the headrest assembly 10 is actuated manually or electromechanically, the headrest assembly 10 may include a horizontal adjustment mechanism 30 including a track assembly 31 that guides movement of the headrest assembly 10. In particular, the horizontal adjustment mechanism 30 includes a headrest track member 32 that is engaged with a seatback track member 34 for movement therealong. In the illustrated embodiment of FIG. 2, the headrest track member 32 is disposed within the seatback track member 34, but it is to be appreciated that the reverse may be the case, with the seatback track member 34 being disposed within the headrest track member 32. As shown, the horizontal adjustment mechanism 30 includes a curved portion 36 to facilitate movement around the corner 22 of the seatback 16.

FIG. 3 illustrates a side view of the headrest assembly 10 with the horizontal adjustment mechanism 30 located in a vehicle seatback 16 in accordance with another embodiment. The headrest assembly 10 connects to the upper portion 18 of the seatback 16 via the armature 14, which is illustrated as a rotatable shaft with a bend 38. In addition, the headrest assembly 10 includes a pivot connection 40 connecting the housing 11 to the armature 14 and allowing the housing 11 to tilt with respect to the seatback 16. The horizontal adjustment mechanism 30 is located within the seatback 16 and effectuates rotational movement of the armature 14 via a motor 42. Because the armature 14 includes a bend 38, rotational movement of a lower portion 46 of the armature 14 results in semi-circular movement of an upper portion 44 of the armature 14. Each seat 16 and/or a location adjacent to the driver's seat may be equipped with a user interface 48, which could include buttons, switches, and/or levers that allow an occupant to move the headrest assembly 10 in the cross-car direction. As shown and described above, the user interface 48 may be located on the vehicle seat 16, but it is to be appreciated that the user interface 48 may be located on the headrest assembly 10, a touch screen or a steering wheel, for example. Furthermore, the user interface may be associated with a vehicle voice activated system or controlled via a paired mobile device. By using the interface 48, the angle of the headrest assembly 10 can be adjusted for a particular occupant's preference, e.g., to a side when the occupant would like to nap or rest. The horizontal adjustment mechanism 30 and the user interface 48 may be connected to a controller 50 for controlling certain settings. The horizontal adjustment mechanism 30, the user interface 48, and the controller 50 are all operably connected to a power source 52. The power source 52 is connected to a vehicular electrical system.

FIG. 4 is a disassembled view of various components of the headrest assembly 10. An internal support structure 13 is located within the housing 11 and provides support to the headrest assembly 10 at various angles. The support structure 13 may be curved to match an outer surface of the headrest assembly 10. The bend 38, the upper portion 44, and the lower portion 46 of the armature 14 are shown along with arrows indicating that rotation of the lower portion 46 results in semi-circular (i.e., circumferential) and horizontal movement of the upper portion 44. The upper portion 44 includes a series of vertically spaced grooves 54 for catching a detent 56 (FIG. 5) and being retained at a vertical height. The lower portion 46 includes a series of teeth 58 for meshing with the motor 42. More particularly, the teeth 58 mesh with a gear 60 having internal teeth 62 that is rotated by the motor 42. The teeth 58 on the lower portion 46 are vertically long enough that they engage with the internal teeth 62 of gear between each vertical setting obtainable by the spaced grooves 54.

FIG. 5 is a top view of the horizontal adjustment mechanism 30 and a corresponding seatback 16 in accordance with yet another aspect of the disclosure. The horizontal adjustment mechanism 30 is similar to that described in reference to FIGS. 1 and 2 and includes a seatback track member 34 and a headrest track member 32. The seatback track member 34 includes a track 64 and the headrest track member 32 includes a carriage 66. The carriage 66 includes a pair of wheels 68 on either side of the track 64 that allow it to slide horizontally therealong. The carriage 66 further includes an, aperture 70 for connection of the armature 14. The carriage 66 may be motorized and/or may be manually adjustable. The upper surface 18 of the seatback 16 is shown above the horizontal adjustment mechanism 30 and includes a cavity 72 having a similar shape to the track 64 that allows the armature 14 to extend therethrough. Opposing sides of the cavity 72 may be lined with members 74 that prevent debris from entering the seatback 16. The members 74 may be a brush-like material or an elastic sheet, such that it can expand and contract upon movement of the armature 14 therethrough. A support structure 76 is vertically retained within the cavity 72 but allowed to slide therealong in the cross-car direction 20. The support structure 76 includes the detent 56 that is captured by the grooves 54 in the armature 14 for vertical adjustment. The detent 56 may further include a back portion 57 (or unlocking portion) for locking and unlocking onto various locations of the cavity 72. The upper portion 44 of the armature 14 may be telescopically connected to the lower portion 46 to assist in vertical alignment without having to move the entire horizontal adjustment mechanism 30.

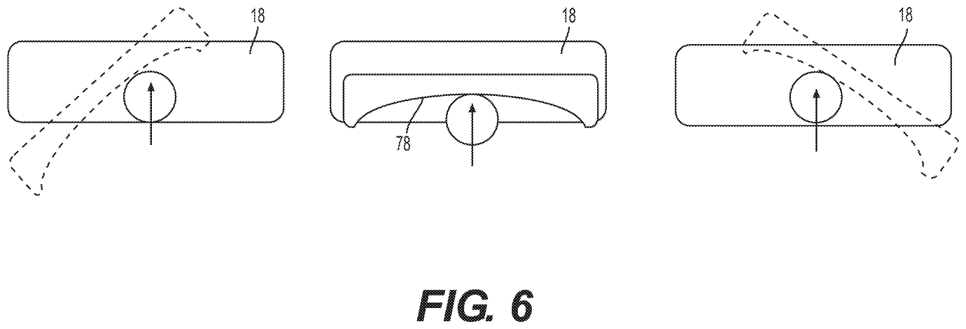

FIG. 6 illustrates a range of movement of the headrest assembly 10 with respect to the top surface 18 of the seatback 16. In certain embodiments, the headrest assembly 10 may include a concave forward facing surface 78 for placement of an occupant's head. The range of movement for the headrest assembly 10 may be limited such that there is always part of the headrest assembly 10 directly behind the occupant's head in the event of a crash. In other embodiments, the pivotable movement of the headrest assembly 10 shown in FIG. 6 is combined with translational cross-car movement described herein.

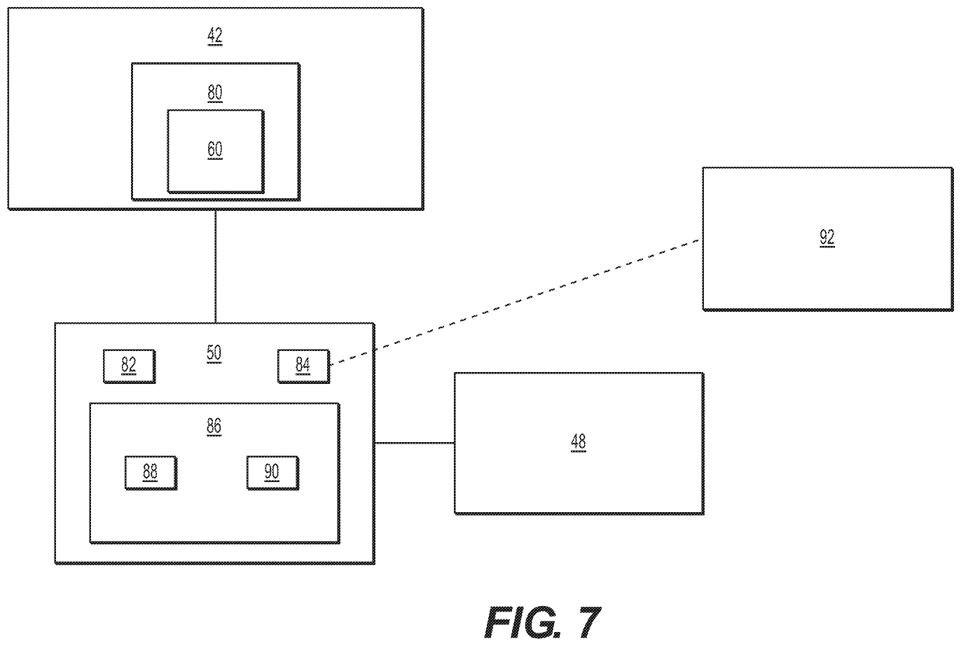

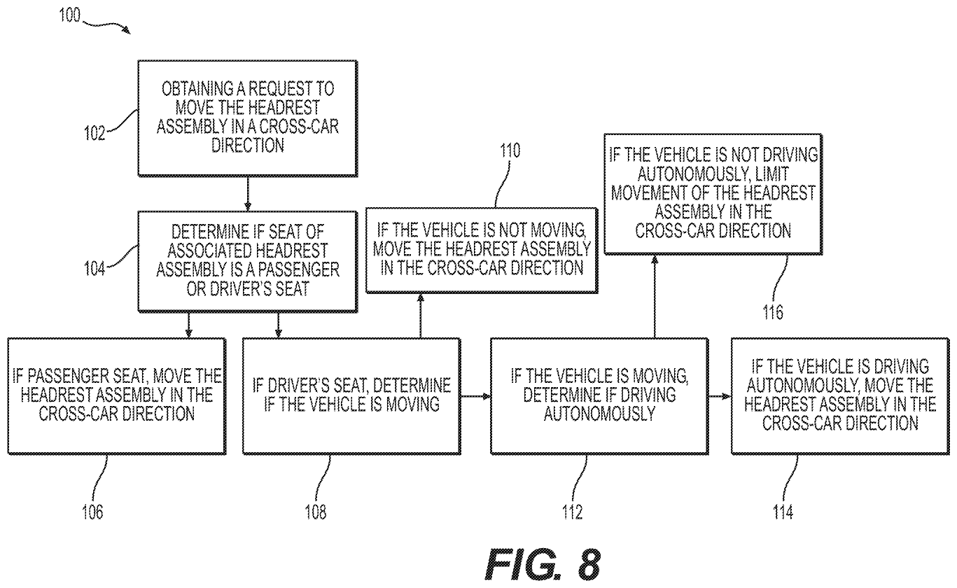

FIG. 7 is a schematic representation of various electrical and mechanical components of the headrest assembly 10. The various elements provided therein allow for a specific implementation. Thus, one of ordinary skill in the art of electronics and circuits may substitute various components to achieve a similar functionality. The controller 50 dictates certain settings of the horizontal adjustment mechanism 30, such as when to move the headrest assembly 10 in the cross-car direction 20. The controller 50 receives information from the user interface 48 and/or a different computing device and instructs the horizontal adjustment mechanism 30 based on certain feedback. In various embodiments, the horizontal adjustment mechanism 30 includes the motor 42 which may include a gear reduction unit 80. The controller 50 includes a microprocessor 82, a communications module 84, and a memory 86 having machine readable non-transitory storage. Programs and/or software 88 are saved on the memory 86. As will be described, profile data 90 of a specific preference may also be stored on the memory 86. The microprocessor 82 carries out instructions based on the software 88, for example, preventing the headrest assembly 10 on the driver's seat from moving in the cross-car direction while the vehicle is being driven in a manual driving mode or low level autonomous driving modes. Software 88 may be updated via the transmission of information between the communications module 84 and one or more computing devices 92. For example, the computing device 92 may be a paired mobile device such as mobile phone, tablet, laptop or wearable technology. Using the interface 48 and or the computing device 92, a driver may save his or her preferred headrest assembly 10 positions into the storage 86 as the profile data 90. For example, if a driver does not have any passengers, they may prefer to have all the headrest assemblies 10 associated with the passenger seats to be moved towards the center of the vehicle. Alternatively, if a driver needs to travel with an elongated work-piece, they may have a preferred setting wherein the headrest assemblies 10 on one side of the vehicle are moved horizontally outwardly or inwardly and/or rotated to take up less forward facing room. It should be appreciated that the controller 50 and associated components may be located in each seat with a headrest assembly 10. Alternatively, it should be appreciated that one controller 50 may be used for instructing multiple headrest assemblies 10.

FIG. 8 illustrates a software implemented method 100 that includes steps associated with moving a headrest assembly for vehicle and/or an autonomous capable vehicle in a cross-car direction. The method 100 may be implemented by the above-described motor in response to instructions from the microprocessor and initially includes a step of obtaining a request to move the headrest assembly in a cross-car direction 102. The method 100 continues by determining 104 if the seat with the associated headrest assembly is a passenger or a driver's seat. If the seat is a passenger seat, the method continues by allowing the headrest assembly to move in the cross-car direction 106. If the seat is a driver's seat, the method continues by determining 108 if the vehicle is moving and/or in drive. If the vehicle is not moving, the method continues by allowing the headrest assembly to move in the cross-car direction 110. If the vehicle is moving, the method continues by determining 112 if the vehicle is driving autonomously. If the vehicle is driving autonomously, the method continues by allowing the headrest assembly to move in the cross-car direction 114. If the vehicle is not driving autonomously (or autonomously at a low level in some embodiments), the method continues by limiting 116 movement of the headrest assembly in the cross-car direction. The step of limiting 116 movement of the headrest assembly in the cross-car direction may include not allowing any movement in the cross-car direction.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A headrest assembly for use in a motor vehicle comprising:
a housing;
an armature operatively coupling the housing to a seatback of a vehicle seat; and
a horizontal adjustment mechanism operatively coupled to the armature, the horizontal adjustment mechanism effectuating movement of the housing in a cross-car direction.

2. The vehicle headrest assembly of claim 1, wherein the horizontal adjustment mechanism includes a headrest track member and a seatback track member, the headrest track member being operably connected to the seatback track member for relative sliding movement.

3. The vehicle headrest assembly of claim 2, wherein the headrest track member includes a carriage connected to the armature and the seatback track member includes a track that the carriage slides along.

4. The vehicle headrest assembly of claim 3, wherein the track includes a curved portion such that movement of the carriage in the cross-car direction at least partially rotates the housing relative to the seatback.

5. The vehicle headrest assembly of claim 4, wherein the headrest assembly includes a concave forward facing surface.

6. The vehicle headrest assembly of claim 5, wherein movement of the carriage is limited such that a portion of the concave forward facing surface is continuously located directly behind an occupant's head.

7. The vehicle headrest assembly of claim 1, wherein the horizontal adjustment mechanism includes an extension of the armature having a bend and a lower portion such that rotation of the lower portion results in semi-circular movement of the housing.

8. The vehicle headrest assembly of claim 1, wherein the horizontal adjustment mechanism includes a motor.

9. The vehicle headrest assembly of claim 8, further comprising a user interface in communication with the motor for changing the position of the housing in the cross-car direction with respect to the seatback.

10. The vehicle headrest assembly of claim 9, wherein the motor is located within the seatback.

11. The vehicle headrest assembly of claim 9, wherein the motor is in communication with a microprocessor for applying software implemented routines.

12. A method of controlling the movement of a headrest assembly in a cross-car direction with a motor that receives instructions from a microprocessor, the microprocessor configured to perform the steps of:
obtaining a request to move the headrest assembly in a cross-car direction; and
instructing the motor to move the headrest assembly in the cross-car direction.

13. The method of claim 12, wherein the microprocessor is further configured to limit movement in the cross-car direction of the headrest assembly on a driver's seatback if the vehicle is moving.

14. The method of claim 13, wherein the vehicle is operable in a manual driving mode and an autonomous driving mode, and the method further comprises determining if the vehicle is driving autonomously, wherein the range of movement of the headrest assembly in the cross-car direction is limited to a first range of movement if the vehicle is in the manual driving mode and the range of movement of the headrest assembly in the cross-car direction is limited to a second range of movement that is greater than the first range of movement if the vehicle is driving in the autonomous driving mode.

15. The method of claim 14, wherein movement of the headrest assembly in the cross-car direction is completely prevented if the vehicle is in manual driving mode.

16. The method of claim 12, further including a plurality of headrest assemblies each located on a respective passenger seat and wherein the microprocessor is further configured to move each of the headrest assemblies in accordance with one of a plurality of saved user profiles.

17. The method of claim 16, wherein movement of each of the headrest assemblies in accordance with the saved user profile is by request from a paired mobile device in operable communication with the microprocessor.

18. The method of claim 16, wherein movement of each of the headrest assemblies in accordance with the saved user profile is by request from a user interface adjacent to a driver's seat in operable communication with the microprocessor.

19. A vehicle including a plurality of vehicle seats that each include a headrest assembly, each of the headrest assemblies comprising:
a housing;
an armature operatively coupling the housing to a seatback of the vehicle seat; and
an horizontal adjustment mechanism operatively coupled to the armature, the horizontal adjustment mechanism effectuating movement of the housing in a cross-car direction of the vehicle.

20. The vehicle of claim 19, wherein the horizontal adjustment mechanism includes a seatback track member defining a curved track and a carriage connected to the armature and moveable along the seatback track.
